(19) United States
(12) Patent Application Publication
(10) Pub. No.: US 2010/0150242 A1
(43) Pub. Date: Jun. 17, 2010

(54) IMAGE DATA DECODING DEVICE AND IMAGE DATA DECODING METHOD

(75) Inventor: Motokazu Ozawa, Osaka (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, OSAKA (JP)

(21) Appl. No.: 12/595,328

(22) PCT Filed: Apr. 3, 2008
(86) PCT No.: PCT/JP2008/000858

§ 371 Date: Oct. 9, 2009

(30) Foreign Application Priority Data
Apr. 11, 2007 (JP) 2007-103627

(51) Int. Cl. H04N 7/26

(52) U.S. Cl. 375/240.16; 375/240.25; 375/E07.123

(57) ABSTRACT

To reduce bandwidth in an image data decoding device including a decoding unit which obtains image data inputted into the image data decoding device and decodes the obtained image data.

A decoding device (100) which decodes a bitstream of an image, includes: a code converting unit (101) which converts the bitstream inputted to the decoding device (100) into a bitstream coded using a second coding rule in which a maximum code length is shorter than in a first coding rule by which the bitstream has been coded; and an image decoder (103) which obtains the bitstream that has been converted by the code converting unit (101), and decodes the obtained bitstream.

### TECHNICAL FIELD

The present invention relates to an image decoding technique of performing data conversion in order to reduce a bandwidth required to transmit a bitstream, and more specifically relates to an image decoding method and an image decoding device which perform data conversion in order to minimize a maximum code length of compressed image data.

### BACKGROUND ART

In recent years, the H.264 standard (Non-Patent Reference 1) and the VC-1 standard (Non-Patent Reference 2) are being adopted as image coding techniques, in order to implement high-compression of moving picture data. In these techniques, compressed image data (hereinafter called bitstream) is temporarily stored in a buffer. The stored bitstream is transmitted to an image decoder within a certain time limit in order to maintain the real-timeliness of image decoding. In recent years, this time limit is becoming shorter because of increased high-definition of images and simultaneous transmission of plural images, and as a result, the bandwidth (amount of data to be transmitted÷transmission time) required for transmitting a bitstream to the image decoder within the time limit is increasing.

In addition, in the H.264 standard and the VC-1 standard, although an image is decoded by being divided into plural blocks, the coding result for each block (hereinafter called a macroblock) can be of a wide range extending from 0 bits to several 1000 bits. As such, in order to transmit the bitstream to the image decoder within the time limit, it is necessary to presume the case where the coding result of a macroblock is the maximum bit amount, and thus a large bandwidth becomes necessary in order to transmit the bitstream to the image decoder.

As described above, in recent years, the bandwidth for transmitting the bitstream to the image decoder has increased considerably. However, in the H.264 standard and the VC-1 standard, as a an implementation problem, there are no constraints in the method for transmitting a bitstream to the image decoder, and thus the bandwidth for transmitting the bitstream to the image decoder becomes a problem in the configuration of an image decoding device.

To solve this problem, it is necessary to reduce the bandwidth for transmitting the bitstream to the image decoder. Since this bandwidth is determined by the maximum bit amount of the macroblock coding results as described earlier, it is sufficient to reduce the bit amounts of the macroblock coding result so that the maximum bit amount of the macroblock coding results does not exceed the bit amount that can be transmitted using a provided bandwidth.

Meanwhile, Patent Reference 1 shows a method for reducing the bit amounts of macroblock coding results. The method in Patent Reference 1 reduces the bit amounts of the macroblock coding results by converting, into codes of higher compression rate, the respective codes (a mode code indicating the coding method, a motion vector code, a code indicating a DCT coefficient, and so on) in a macroblock that is coded using the MPEG-2 standard. However, since the method in Patent Reference 1 is intended for reducing an average bit amount of the macroblock coding results, there is no assurance that the maximum bit amount of the macroblock coding results will be reduced.

FIG. 1 is a diagram showing a coding rule for codes before conversion, in the code conversion in Patent Reference 1.

FIG. 2 is a diagram showing a coding rule for codes after conversion, in the code conversion in Patent Reference 1.

Specifically, in Patent Reference 1, although the codes in FIG. 1 are converted into the codes in FIG. 2, the maximum number of bits of code, that is, the number of bits of the code at the lowest level in the chart in FIG. 1 and the number of bits of the code at the lowest level in the chart in FIG. 2 are both six bits, and are thus mutually the same.
Non-Patent Reference 1: H.264 ISO/IEC 14496-10 standard, ITU-T H.264 standard
Non-Patent Reference 2: SMPTE 421M-2006 Television—VC-1 Compressed Video Bitstream Format and Decoding Process
Patent Reference 1: Japanese Unexamined Patent Application Publication No. 2005-94693

### DISCLOSURE OF INVENTION

### Problems that Invention is to Solve

However, in the method for reducing the macroblock bit amount having the above-described conventional configuration, since the problem is the reduction of average bit amounts of the macroblock coding results and not the maximum bit amount of the macroblock coding results, reduction of the maximum bit amount of the macroblock coding results is not possible.

Furthermore, when configuring an image decoder which decodes an image in real time within the range indicated by the image coding standards in Non-Patent Reference 1 and so on, the bandwidth for transmitting a bitstream to the image decoder is determined according to the maximum bit amount of the macroblock coding results. In the image coding specifications in Non-Patent Reference 1 and so on, the bit amounts of the macroblock coding results vary for each macroblock in a range extending from 0 bits to several 1000 bits. As a result, when performing real time image decoding, there is the problem that the bandwidth for transmitting a bitstream to the image decoder becomes large, and the cost of the image data decoder resulting from the enhancement of the performance of the buffer for storing the bitstream increases.

In this manner, there exists, conventionally, an image data decoding device which decodes image data and includes a decoding unit which obtains image data inputted to the decoding device, and decodes the obtained image data. However, at the time when the technique for the standard was conceived, it was not foreseen that, due to increased high-definition of images and simultaneous transmission of images, the bandwidth for transmitting image data would increase considerably. On the other hand, in the process of actually creating an image data decoding device implementing the standards, the occurrence of the problem that the maximum bit amount of the macroblock coding results becomes large and thus the required bandwidth becomes large, has been recognized.

Here, for example, with CABAC codes in the H.264 standard, the bitstream of the coding result is compressed using arithmetic codes. With the arithmetic codes used in CABAC codes, since decoding must be a serial process, it is difficult to obtain a decoding performance that suits the processing performance of the image decoder. Consequently, a decoding device which handles CABAC codes is configured so that the decoding results for the arithmetic codes are stored in a buffer corresponding to the CPB of the standard, and an image decoder decodes the result of the decoding of the arithmetic codes. However, with this configuration, the restored results of compressing the arithmetic codes are transmitted to the image decoder, and thus the maximum bit amount for the macroblocks is large at about 5000 bits, and the required bandwidth for transmitting the decoding results from the buffer to the image decoder becomes extremely large. For example, in this manner, the problem that the maximum bit amount for the macroblocks becomes large and the required bandwidth becomes large occurs.

Such a problem is a problem that is common to image data decoding devices which decode image data.

Consequently, the present invention is conceived to solve such problem and has as an object to provide a decoding device that can reduce the maximum bit amount of the macroblock coding results.

### Means to Solve the Problems

In order to solve the above-described conventional problem, the image data decoding apparatus according to the present invention adopts the subsequent configuration.

The image data decoding device according to an aspect of the present invention is an image data decoding device which decodes image data, the image data decoding device including: a code converting unit configured to convert image data inputted to the image data decoding device into image data coded according to a second coding rule in which a maximum code length is shorter than in a first coding rule used to code the inputted image data; and a decoding unit configured to obtain the image data after the conversion by the code converting unit, and to decode the obtained image data.

Furthermore, a computer program according to an aspect of the present invention is a computer program for causing an image data decoding device to decode image data, the computer program causing the image data decoding device to execute: a code converting function of converting image data inputted to the image data decoding device into image data coded according to a second coding rule in which a maximum code length is shorter than in a first coding rule used to code the inputted image data; and a decoding function of obtaining the image data after the conversion through the code converting step, and decoding the obtained image data.

It should be noted that, in the case where other data aside from image data is transmitted through the bus, the “bandwidth” identified by the bandwidth information and through which the image data is transmitted in claim 3 is assumed to be the bandwidth related to the transmission of image data excluding the portion concerning such other data, out of the entire bandwidth. The “bandwidth information” may be, for example, a target bit amount for image data or a target bit amount for units-of-transmission included in image data. Furthermore, the reducing unit may remove a DC coefficient only when a predetermined AC coefficient is not included within the unit-of-transmission of the image data.

On the other hand, the image data decoding device in an aspect of the present invention may be as described below. That is, the image data decoding device in an aspect of the present invention may be an image data decoding device including: a data converting unit which converts image data coded according to a first coding rule into image data coded according to a second coding rule in which a maximum code length is shorter than in the first coding rule; and an image decoding unit which decodes the image data converted by the converting unit.

According to this image data decoding device, by taking advantage of the fact that the bandwidth of a bitstream to be inputted to the image decoder is determined by the maximum bit amount of the result of coding macroblocks; applying, to the input bitstream, the conversion into codes in which the maximum bit amount for the macroblocks is reduced or the reduction of the amount of information such that the maximum bit amount for the macroblocks is reduced; and, in addition, by configuring the image decoder so as to handle the code conversion or information amount reduction that has been applied, it is possible to reduce the bandwidth of a bitstream inputted to the image decoder, and provide a decoding device which can reduce the bandwidth of a bitstream inputted to the image decoder.

It should be noted that the data converting unit may perform code conversion separately for motion vector information and coefficient values.

Furthermore, the image data decoding device may further include: a buffer which stores image data outputted from the data converting unit; and an obtaining unit which obtains a bandwidth for the buffer, wherein the data converting unit may perform data transmission when the maximum data length of the image data in the unit-of-transmission to the buffer exceeds the bandwidth obtained by the obtaining unit.

Furthermore, the image data decoding device may further include: a buffer which stores image data outputted from the data converting unit; an obtaining unit which obtains a bandwidth for the buffer; a bit number control unit which obtains a bandwidth for image data outputted from the buffer, sets a target value based on the obtained bandwidth, counts, for each unit-of-transmission, the number of bits for the code-converted image data on which code conversion has been performed, and sends out a data reduction command when the counted number of bits exceeds the target value; and a reducing unit which reduces the number of bits of the code-converted image data, upon receiving the reduction command.

Furthermore, the reducing unit may reduce the number of bits in the order of a luminance AC, a chrominance AC, a luminance DC, and a chrominance DC.

Furthermore, the first coding rule may be a coding rule for coding to unequal-length codes, the second coding rule may be a coding rule for coding in which unequal-length codes and equal-length codes are switched and the maximum code length in the second coding rule is a code length of equal-length code.

Furthermore, the present invention may be configured as a decoding method of decoding image data, the method including: converting image data coded according to a first coding rule into image data coded according to a second coding rule in which a maximum code length is shorter than in the first coding rule; and decoding the image data converted in the converting.

Furthermore, the present invention may be configured as an integrated circuit used in a decoding device which decodes image data, the integrated circuit including: a data converting unit which converts image data coded according to a first coding rule into image data coded according to a second coding rule in which a maximum code length is shorter than in the first coding rule; and an image decoding unit which decodes the image data converted by the converting unit.

### EFFECTS OF THE INVENTION

In order to reduce the bandwidth to the image decoder, the present invention, by being provided with a converting unit which reduces the maximum number of bits for code lengths, converts a bitstream into codes configured such that the maximum bit amount for macroblocks is reduced, before the bitstream is stored in a buffer, and decodes the bitstream after conversion, using an image decoder. Accordingly, since the maximum bit amount of the macroblock coding result is reduced, it is possible to reduce the bandwidth for transmitting a bitstream to the image decoder, which is required for real-time image decoding. Furthermore, since high-performance is not required of the buffer for storing the bitstream, the image decoder can be implemented at a lower cost.

### BRIEF DESCRIPTION OF DRAWINGS

FIG. 1 is a diagram showing a coding rule for codes before conversion, in the code conversion in Patent Reference 1.

FIG. 2 is a diagram showing a coding rule for codes after conversion, in the code conversion in Patent Reference 1.

FIG. 3 is a configuration diagram of an aspect of the present invention.

FIG. 4 is a configuration diagram of a code converting unit.

FIG. 5 is a flowchart showing the operation of the code converting unit.

FIG. 6 is a diagram showing the coding (CAVLC) of motion vectors before code conversion.

FIG. 7 is a diagram showing the coding (CAVLC) of motion vectors after code conversion.

FIG. 8 is a diagram showing the coding (CAVLC) of coefficient values before code conversion.

FIG. 9 is a diagram showing the coding (CAVLC) of coefficient values after code conversion.

FIG. 10 is a configuration diagram of a second embodiment.

FIG. 11 is a configuration diagram of a coefficient reducing unit.

FIG. 12 is a flowchart showing the operation of a coefficient reducing unit.

FIG. 13 is a flowchart showing the operation in coefficient removal.

FIG. 14 is a configuration diagram of a third embodiment.

FIG. 15 is a diagram showing the coding (CABAC) of motion vectors before code conversion.

FIG. 16 is a diagram showing the coding (CABAC) of motion vectors after code conversion.

FIG. 17 is a diagram showing the coding (CABAC) of coefficient values before code conversion.

FIG. 18 is a diagram showing the coding (CABAC) of coefficient values after code conversion.

FIG. 19 is a diagram showing the coding (CABAC) of reference image indices and quantization parameters before code conversion.

FIG. 20 is a diagram showing the coding (CABAC) of reference image indices and quantization parameters after code conversion.

FIG. 21 is a diagram showing a decoding device 100C in a fourth embodiment.

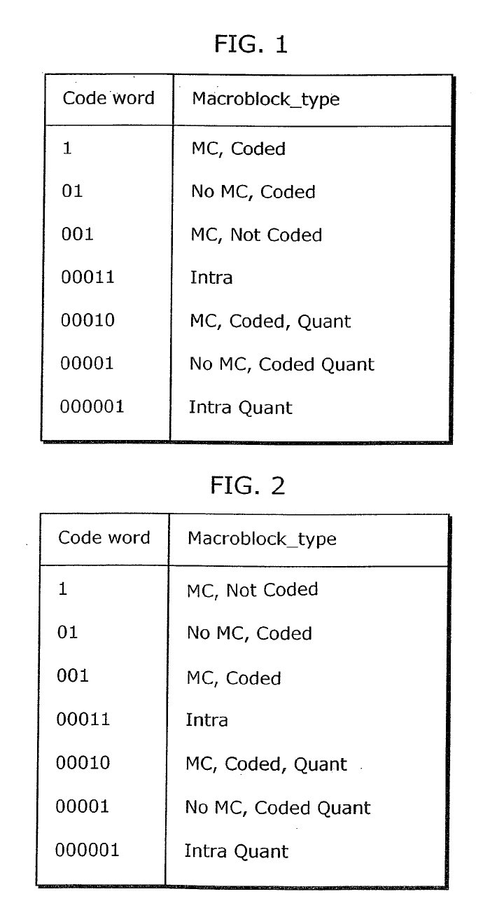

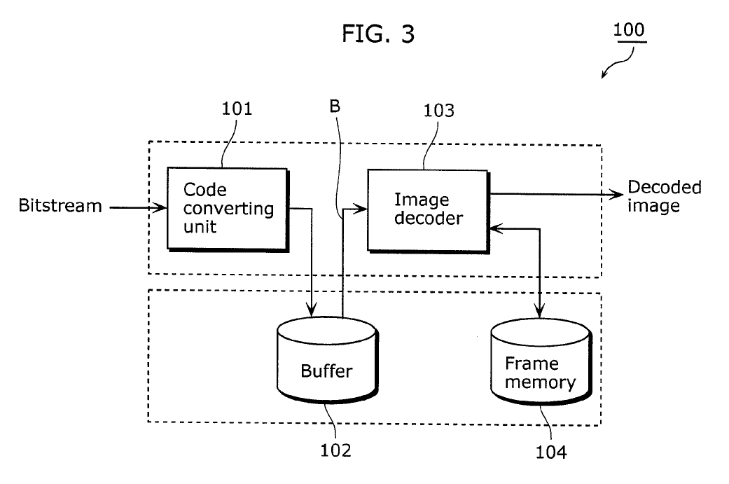

### NUMERICAL REFERENCES

100 Decoding device
101 Code converting unit
102 Buffer
103 Image decoder
104 Frame memory
201 Bitstream decoding unit
202 Bitstream generating unit
203 Stream code converting unit
204 Motion vector code converting unit
205 Coefficient value code converting unit
100A Decoding device
801 Coefficient reducing unit
901 Bitstream decoding unit
902 Reducing unit
903 Bitstream generating unit
904 Bit amount measuring unit
905 Coefficient reduction control unit
100B Decoding device
1201 Arithmetic code decoder
1202 Code converting unit
1203 Coefficient reducing unit
100C Decoding device
1301 Post-conversion maximum code length identifying unit
1304 Switching unit
1303 Rule type-display flag adding unit

### BEST MODE FOR CARRYING OUT THE INVENTION

Hereinafter, embodiments of the present invention shall be described with reference to the Drawings.

### First Embodiment

FIG. 3 is a configuration diagram of a decoding device 100 in a first embodiment of the present invention. Hereinafter, the operation of the decoding device 100 shall be described using FIG. 3.

The decoding device 100 in FIG. 3 includes: a code converting unit 101 which performs the conversion of a code; a buffer 102 for storing an output of the code converting unit 101; an image decoder 103 which reads a bitstream from the buffer and decodes an image; and a frame memory 104 for storing an image which is a result of the decoding by the image decoder 103.

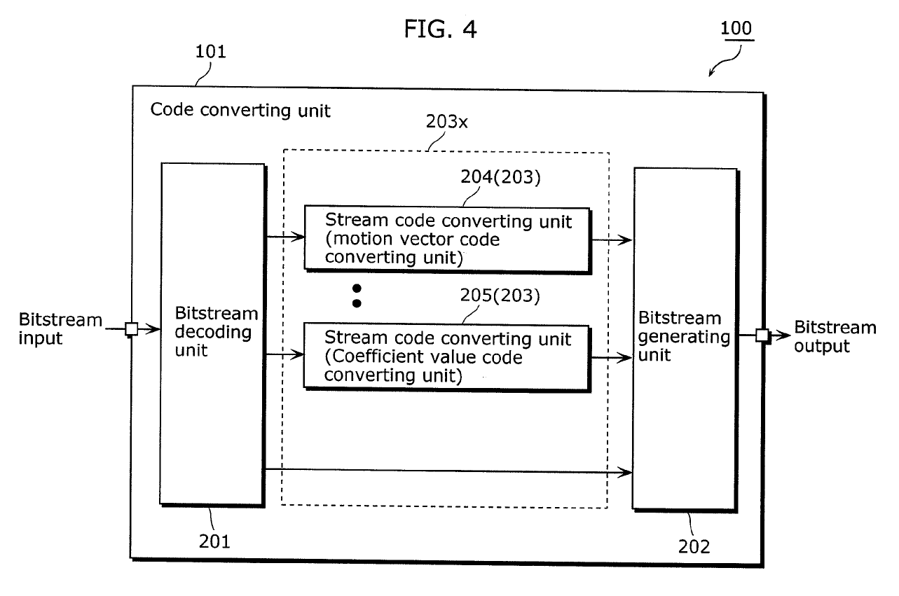

The code converting unit 101 reads a bitstream coded according to the H.264 standard from a source outside the decoding device 100, processes the read bitstream according to the code conversion procedure described later (see description for FIG. 4 to FIG. 9), and outputs the processing result, as a bitstream, to the buffer 102.

The buffer 102 functions as a CPB (Coded Picture Buffer) required in the H.264 standard, and stores the bitstream outputted from the code converting unit 101 into a storage device such as a memory, and so on, and outputs the stored bitstream in response to a read request from the image decoder 103.

The image decoder 103 obtains the bitstream in the form outputted by the code converting unit 101, decodes the obtained bitstream, and outputs an image which is the decoding result. It should be noted that, in the image decoder 103, a variable-length code decoding unit of a decoder compatible to the H.264 standard has been altered to allow decoding of the bitstream outputted by the code converting unit 101. As a result, in order to properly decode an image, the conversion performed by the code converting unit 101 is performed in such a way that there is no impact on regulations other than that for the variable-length coding in the image coding standard. It should be noted that such image decoder 103 and code converting unit 101 are examples and do not place any limitations.

The frame memory 104 stores the decoding result images outputted by the image decoder 103, into a storage device such as a memory and so on. The image stored by the frame memory 104 is used as a reference image at the time of image decoding and as a buffer at the time of decoding result outputting, and so on.

FIG. 4 is a configuration diagram of the code converting unit 101 in the first embodiment. The code converting unit 101 shown in FIG. 4 converts the bitstream coded according to the H.264 standard into codes configured so as to reduce the maximum bit amount for the macroblocks.

A bitstream decoding unit 201 decodes the bitstream coded according to the image coding standard, and sends the input bitstream directly to a bitstream generating unit 202 when a stream code converting unit 203 (stream code converting units 203x) will not perform conversion, and sends the input bitstream to the stream code converting unit 203 (stream code converting units 203x) when conversion is to be performed.

The bitstream generating unit 202 binds the bitstreams outputted from the bitstream decoding unit 201 and the stream code converting unit 203, and outputs the result as a bitstream that can be decoded by the image decoder 103.

The stream code converting unit 203 converts the codes outputted by the bitstream decoding unit 201 into codes configured so that the maximum bit amount is reduced, and outputs each code in the conversion result as a bitstream to the bitstream generating unit 202. The stream code converting units 203x include, as stream code converting units 203, a motion vector code converting unit 204 and a coefficient value code converting unit 205, that is, the motion vector code converting unit 204 and the coefficient value code converting unit 205 are included among the plural stream code converting units 203 that are included in the stream code converting units 203x. Details of these shall be described later.

Hereinafter, the procedure for code conversion of CAVLC (Context Adaptive Variable Length Coding) codes in the H.264 standard shall be described.

In the application of the present invention to CAVLC codes, the code converting unit 101 converts only the motion vector (hereafter denoted as mvd) and the coefficient value (hereafter denoted as level) among the parameters included in a bitstream (denoted in the standard as macroblock_layer( ), into codes in which the maximum code length is reduced, and outputs the others without performing conversion. The reason why only the mvd and the level are converted in the present embodiment is that, in a macroblock of which the bit amount is the maximum, most of the bits are used in the coding of the mvd and the level.

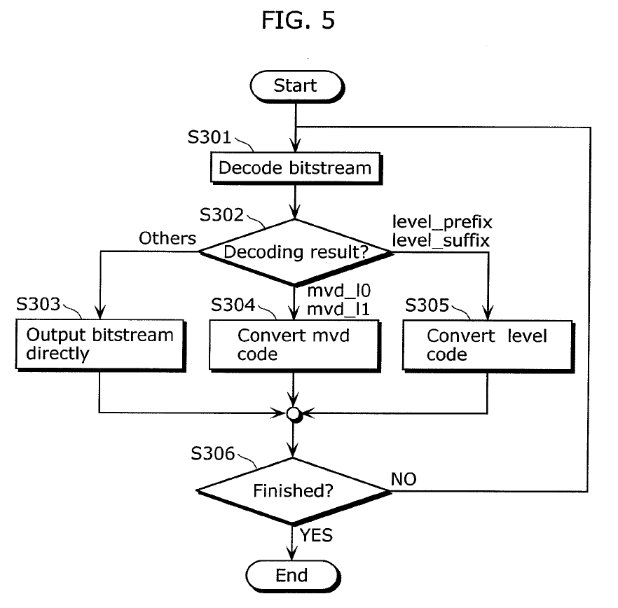

FIG. 5 is a flowchart showing the operation of the bitstream decoding unit 201 (FIG. 4) in the present embodiment.

The bitstream decoding unit 201 decodes an inputted bitstream in accordance with the standard (step S301). Next, the bitstream decoding unit 201 classifies the decoding result of the preceding step S301 into: mvd_I0 and mvd_I1 which correspond to motion vectors; level_prefix and level_suffix which correspond to coefficient values; and others (step S302). Furthermore, based on the result of the classification in step S302, the bitstream decoding unit 201 outputs the others aside from the motion vectors and the coefficient values directly to the bitstream generating unit 202 (see FIG. 4, step S303), and outputs the motion vectors to the motion vector code converting unit 204 (the stream code converting unit 203 at the upper part of FIG. 4) (step S304) and outputs the coefficient values to the coefficient value code converting unit 205 (the stream code converting unit 203 at the lower part of FIG. 4) (step S305).

It should be noted that the above-described others aside from the motion vectors and the coefficient values, which the bitstream decoding unit 201 outputs directly to the bitstream generating unit 202 in step S303, are mostly 1 bit data or data that is coded using a fixed-length code, for example. By not performing code conversion up to the others portion mentioned above, the decoding device 100 allows the configuration of the device to be simplified. Inversely, according to the decoding device 100, code conversion is performed on motion vectors and coefficient values, which are data of two bits or more and data that are coded using variable-length codes, and thus the bus length can be sufficiently reduced while simplifying the configuration of the device.

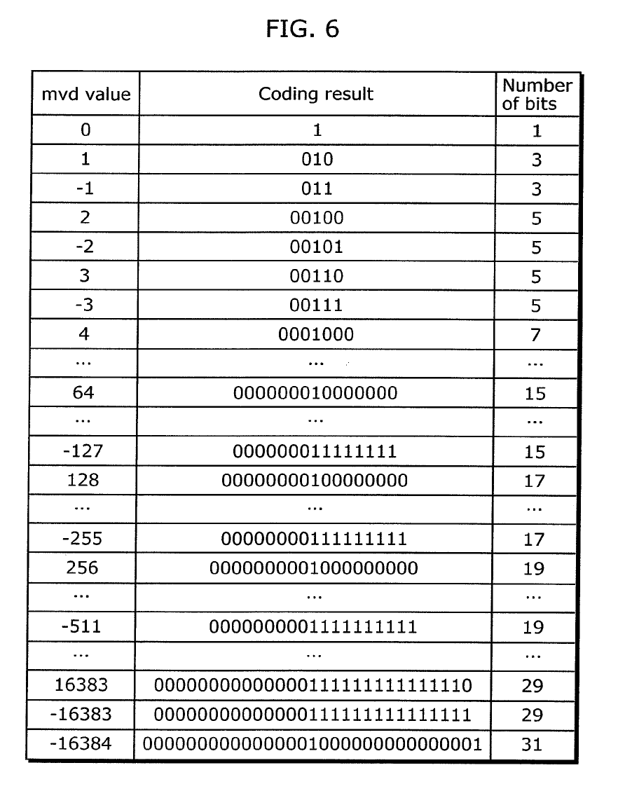

FIG. 6 is a diagram showing a coding rule for motion vectors, prior to the performance of the code conversion (step S304 in FIG. 5) by the motion vector code converting unit 204.

The motion vector code converting unit 204 performs code conversion on the inputted motion vectors (step S304 in FIG. 5). Next, the code conversion of motion vectors shall be described. In the CAVLC codes in the H.264 standard, mvd_I0 and mvd_I1 are coded using Exp-Golomb codes such as those shown in FIG. 6. Since the value of mvd_I0 and mvd_I1 are restricted to −16384 to 16383 in the standard, the maximum code length for mvd_I0 and mvd_I1 in this coding is 31 bits. Since mvd_I0 and mvd_I1 appear a maximum of 32 times based on the standard, the maximum bit amount is 992 bits. As such, the shortening of the maximum code length for mvd_I0 and mvd_I1 is effective for macroblock maximum bit amount reduction.

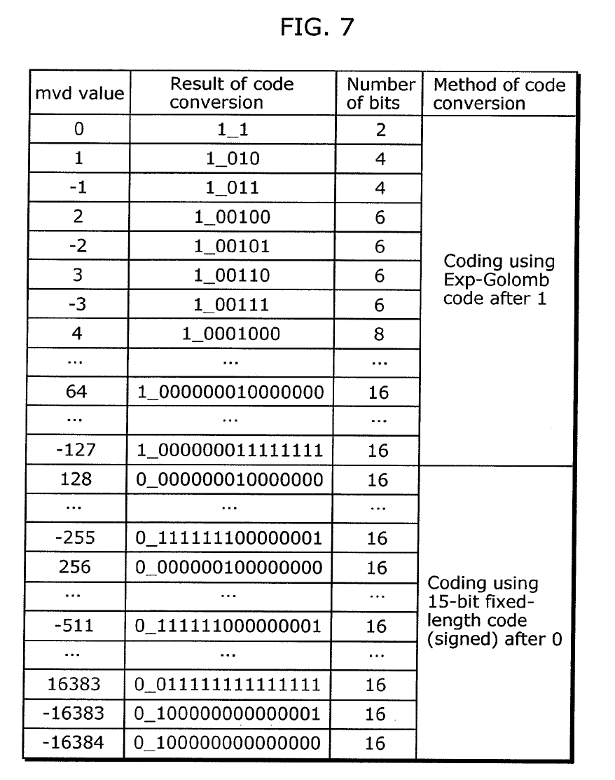

FIG. 7 is a diagram showing a coding rule for motion vectors, after the performance of the code conversion (step S304 in FIG. 5) by the motion vector code converting unit 204 (FIG. 4). FIG. 7 shows an example of codes that are configured so as to reduce the maximum bit amount of mvd_I0 and mvd_I1.

These codes take advantage of the fact that the values of mvd_I0 and mvd_I1 can be expressed by 15-bit signed fixed-length codes, and a fixed-length code is adopted for an absolute value of 128 or higher for which 15 bits or more become necessary using the original Exp-Golomb code, and the Exp-Golomb code is adopted for the others. In this case, since it is necessary to judge which between coding using fixed-length code and coding using Exp-Golomb code the coding method is in the decoding of the bitstream after the conversion, 0 is added to the beginning of the code when it is a fixed-length code, and 1 is added when it is a Exp-Golomb code. With this code conversion, the maximum code length of mvd_I0 and mvd_I1 is reduced from 31 bits to 16 bits, and the maximum bit amount for macroblocks is reduced from 992 bits to 512 bits. On the other hand, in this code conversion, the code length increases 1 bit when the absolute value is 127 or lower. In general, since the absolute value of mvd_I0 and mvd_I1 are often small, the average number of bits for macroblocks increases due to this conversion. However, for a macroblock for which the absolute value of mvd_I0 and mvd_I1 are small, very often the bit amount for the entire macroblock becomes significantly smaller than the maximum bit amount, and thus the increase in the macroblock maximum bit amount caused by the 1-bit increase of the code length when absolute value is 127 or lower can be disregarded.

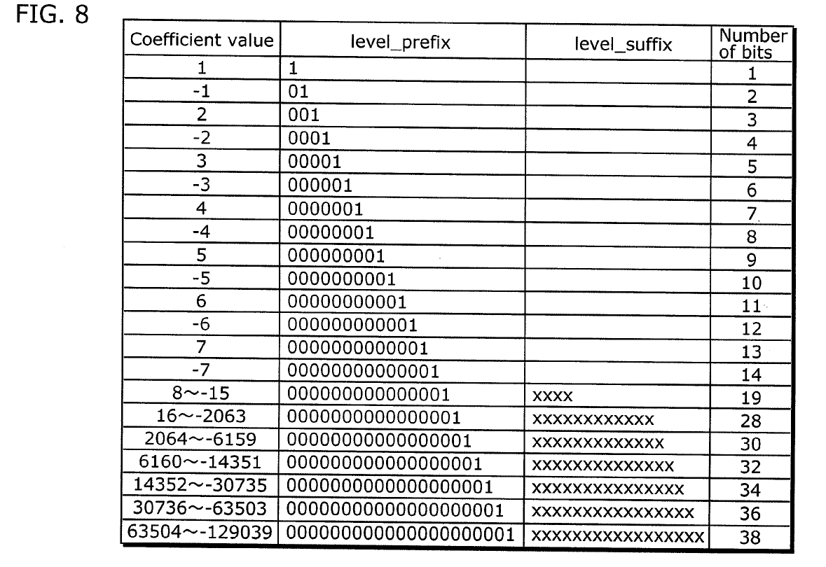

FIG. 8 is a diagram showing a coding rule for coefficient values, prior to the performance of the code conversion (step S305 in FIG. 5) by the coefficient value code converting unit 205 (FIG. 4).

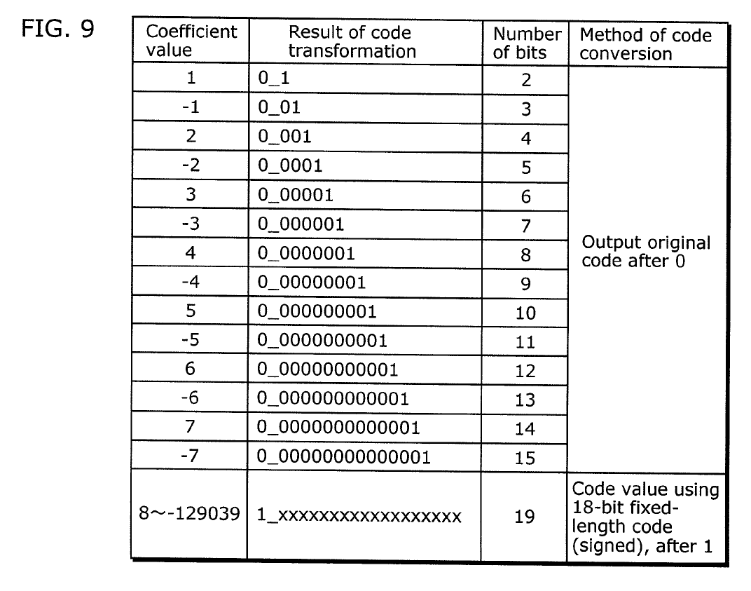

FIG. 9 is a diagram showing a coding rule for coefficient values, after the performance of the code conversion (step S305 in FIG. 5) by the coefficient value code converting unit 205 (FIG. 4).

The coefficient value code converting unit 205 performs code conversion on the coefficient values (step S305). Next, the code conversion of coefficient values shall be described. In the CAVLC code in the H.264 standard, the coefficient values are denoted as the two codes level_prefix and level_suffix as shown in FIG. 8. It should be noted that although, in the standard, the length of the level_suffix is switched among seven types of tables depending on the coefficient value coded immediately before, the code conversion described here can be applied in all the tables using the same concept, and thus a table of suffix_length=0 shown in FIG. 8 shall be described from here on.

Since the range of the coefficient values is restricted to −131072 to 131071 in the standard, the coefficient values can be represented using 18-bit signed fixed-length codes. Consequently, in FIG. 8, 18-bit fixed-length codes are adopted only for the codes in the levels from coefficient value 8 to −129039 downward in which the total of the code lengths of the level_prefix and the level_suffix exceed 18, and the other codes use the original codes as is. In this case, at the time of decoding the bitstream after the conversion, it is necessary to select the coding method from one using fixed-length codes and one using the original codes, in the same manner as in the case of motion vectors. Consequently, 1 is added before the code in the case of a fixed-length code, and 0 is added before the code in the case of an original code. A result of applying this conversion to the coefficient values is shown in FIG. 9. As shown in the figure, as a result of the conversion, the maximum code length of the coefficient values is reduced from 38 bits to 19 bits, and the maximum bit amount for the macroblocks can be significantly reduced. On the other hand, due to this code conversion, the bit length increases 1 bit when the absolute value of the coefficients is 7 or lower. In general, since the absolute value of coefficients is often small, the average number of bits for macroblocks increases due to this conversion. However, for a macroblock for which the absolute value of coefficients are small, the bit amount for the entire macroblock becomes smaller than the maximum bit amount, and thus the increase in the macroblock maximum bit amount caused by the 1-bit increase of the code length can be disregarded.

The decoding device 100 repeatedly executes the above-described processing in FIG. 5 until the processing in FIG. 5 is finished (step S306).

In this manner, the decoding device 100 is a decoding device 100 which decodes image data (bitstream, macroblock), and includes the code converting unit 101 (FIG. 3) which converts the image data inputted to the decoding device 100 into image data coded according to another coding rule (FIG. 7, FIG. 9) in which the maximum code length is shorter than that in the coding rule (FIG. 6, FIG. 8) according to which the inputted image data was coded, and the image decoder 103 (FIG. 3) which obtains the image data after the conversion by the code converting unit 101, and decodes the obtained image data.

In addition, the image data includes motion vectors and coefficient values, and the code converting unit 101 includes: the motion vector code converting unit 204 (FIG. 4) which converts the motion vectors included in the image data and which are coded according to the coding rule in FIG. 6, into motion vectors that are coded using the coding rule in FIG. 7 in which the maximum code length is shorter than in the coding rule in FIG. 6; and the coefficient value code converting unit 205 (FIG. 4) which converts the coefficient values included in the image data and which are coded according to the coding rule in FIG. 8, into coefficient values that are coded using the coding rule in FIG. 9 in which the maximum code length is shorter than in the coding rule in FIG. 8. The code converting unit 101 applies the conversion performed by the motion vector code converting unit 204 and the coefficient value code converting unit 205 to the image data.

It should be noted that, in this manner, with the “code converting unit” described in the Claims, in the case where the image data is divided into n (n≧2) portions and the respective portions are coded according to a mutually different type of coding rule, image data of a k-th portion coded according to a first coding rule of a k-th type (1≦k≦n) may be converted to image data of the k-th portion coded according to a second coding rule of the k-th type (1≦k≦n), and the maximum code length of the second coding rule of the same k-th type may be shorter than the maximum code length of the first coding rule of the k-th type. It should be noted that, in this case, the image data need not be made up of only the above-described n portions, and may be configured of the above-described n portions and other portions.

Furthermore, the decoding device 100 further includes the buffer 102 for storing the image data after the conversion by the code converting unit 101, and the image decoder 103 obtains the image data stored in the buffer 102 and decodes the obtained image data. The decoding device 100 further includes a bus B for transmitting image data between the buffer 102 and the outside of the buffer 102. As shown in FIG. 6 to FIG. 9, coding rules are the associations between values and codes denoting such respective values. A code is bit string in which plural 1-bit data are lined up, and the maximum code length is the number of bits of the bit string of a code having the longest bit string among the respective codes to which corresponding values are associated with in the coding rule. The code converting unit 101 converts each code included in the image data, into the code that is associated in the coding rules in FIG. 7 or FIG. 9 with the value associated with such code to be converted in the coding rules in FIG. 6 or FIG. 8, respectively.

Furthermore, in the coding rule in FIG. 7, the average code length is longer than that in the coding rule in FIG. 6. In the coding rule in FIG. 9, the average code length is longer than that in the coding rule in FIG. 8.

Furthermore, the respective codes for which associations are established according to the coding rule in FIG. 7 include: short code length codes (the codes of respective values 0 to −127 in FIG. 7) which are associated with respective values (respective values 0 to −127 in FIG. 6) associated with a shorter code that is below a switching size (15 bits) that is predetermined in the coding rule in FIG. 6; and long code length codes (the codes of respective values 128 to −16384 in FIG. 7) which are associated with respective values (respective values 128 to −16384 in FIG. 6) associated with codes that are longer than the switching size (15 bits) in the coding rule in FIG. 6.

Here, in the case where all the values (0 to −16384) for which associations are established according to the coding rule in FIG. 6 are to be coded using equal-length codes, the above-mentioned switching size (15 bits) is the minimum number of bits required for such equal length code. The code length (15 bits) of such equal-length code is obtained by a binary logarithmic value of x (log (x)), assuming x to be the number of all the values (0 to −16384) to be associated mentioned above.

In addition, in both cases of the aforementioned short code length codes and the aforementioned long code length codes, the code for which association is established according to the coding rule in FIG. 7 includes: an identification bit (0 or 1) which is 1-bit data in the beginning of the code and which indicates whether the code is a short code length code or a long code length code, and a body starting from the second bit onward.

For example, a code “1_{—}010” corresponding to mvd value 1 in FIG. 7 has “1” as an identification bit, and “010” as a body.

An identification bit has a value 1 when the code in which such identification bit is included is a short code length code described above (the codes of values 0 to −127 in FIG. 7), and has a value 0 when the code in which the identification bit is included is a long code length code.

On the other hand, in the case where the code including the body is a short code length code, the body is the same code as the code associated with the value indicating such short code length code, in the coding rule in FIG. 6. For example, the body “010” in the short code length code “1_{—}010” associated with the value 1 in FIG. 7 is the same as the “010” associated with the same value 1 in FIG. 6.

In addition, in the case where the code including the body is a long code length code, the body is an equal-length code having the size of the above-described switching size. For example, in FIG. 7, the body “00 . . . 01000 . . . 0” of the long code length code “0_{—}00 . . . 01000 . . . 0” corresponding to value 128 is an equal-length code of 15-bits and indicates the value 128. Here, the body (“00 . . . 01000 . . . 0”) of the long code length code is an equal-length code indicating the value (128) indicated by such long code length code.

In this manner, in the coding rule in FIG. 7, the respective values associated with a small code (“010” and so on) less than the switching size according to the coding rule in FIG. 6 are each associated with a short code length code (“0_{—}010” and so on) which includes, in at least a part thereof, a code that is the same as such small code, and respective values (128 and so on) associated with a code larger than the switching size are associated with corresponding ones of long code length codes (“0_{—}00 . . . 01000 . . . 0”), each having the switching size (15-bit size), and which include predetermined equal-length codes (“00 . . . 01000 . . . 0” and so on) having mutually equal lengths.

In the same manner, in the coding rule in FIG. 9, respective values associated with a small code (1 to −7) less than the switching size 18 according to the coding rule in FIG. 8 are each associated with a short code length code (“0_{—}001” in FIG. 9 for example) which includes, in at least a part thereof, a code that is the same as such small code (for example, “001” associated with a value 2), and respective values (8 to −129039) associated with a code larger than the switching size are associated with corresponding ones of codes (“1_xxxxxxxxxxxxxxxxxx” shown in FIG. 9), each having the switching size (18-bit size), and which include predetermined equal-length codes having mutually equal lengths. In addition, the switching size is 18 which is the minimum number of bits required when coding, using an equal-length code, all the values (1 to −129039) for which associations are established according to the coding rule in FIG. 8. The equal-length code is a code of equal-length composed of the minimum number of bits, that is, 18 bits. The code in the coding rule in FIG. 9 includes a body (“xxxxxxxxxxxxxxxxxx” in “1_xxxxxxxxxxxxxxxxxx”) including either a code that is the same as that in the coding rule in FIG. 8 or the equal-length code, and an identification bit (“1” in “1_xxxxxxxxxxxxxxxxxx”) identifying whether the code includes a code that is the same as the code in the first coding rule or the equal-length code.

It should be noted that, the decoding device 100 may be a decoding device in which, for example, the code converting unit 101, the buffer 102, the bus B, the image decoder 103, the frame memory 104 are implemented in a integrated circuit (LSI) included in the decoding device 100.

It should be noted that the code converting unit 101 may be configured as a circuit having, for example, the codes before conversion shown in FIG. 6 or FIG. 8 as input codes, and having the codes after conversion shown in FIG. 7 or FIG. 9, respectively, as output codes, and thus outputting output codes corresponding to the input codes. When configured as such a circuit, the code converting unit 101 may adopt a circuit configuration based on the association between input codes shown in FIG. 6 and FIG. 8 and output codes having the same mvd value as the mvd value of the input codes.

In this manner, according to the code conversion in the present embodiment, the maximum bit amount for the macroblocks is reduced, and thus it is also possible to reduce the bandwidth for transmitting the bitstream to the decoder, determined based on the maximum bit amount for the macroblocks. It should be noted that the image decoder 103 in the present embodiment is a variable-length code decoding unit for handling motion vectors and coefficient values out of the image decoding processes stipulated in the standards, that has been modified to handle the codes in FIG. 7 and FIG. 9.

With such a decoding device 100, inputted image data is converted by the code converting unit 101 into image data of the coding rule in FIG. 7 having a short maximum code length, and thus image data coded using a coding rule having a short maximum code length can be transmitted within the decoding device 100, and the bus width in the decoding device 100 can be reduced.

Although the first embodiment of the present invention has been described up to this point, various modifications are possible in the present embodiment within a scope that does not exceed the essence of converting codes to reduce the maximum code length. As an example of a modification, application to image coding standards other than H.264, such as VC-1 or MPEG-2, is possible. Since motion vectors and coefficient values occupy the majority of the maximum bit amount for macroblocks even in image coding standards other than H.264, the same effect as in the present embodiment can be obtained by converting the respective codes into codes in which the maximum code length is reduced.

It should be noted that each function block shown in FIG. 3 is typically implemented as an LSI which is an integrated circuit. The broken lines in FIG. 3 indicate typical configurations of an LSI, and indicate the integration of the code converting unit 101 and the image decoder 103 as an LSI, and the integration of the buffer 102 and the frame memory 104 as a memory LSI such as a DRAM and so on. However, the method of integration is not limited to this example, and the respective functions may be made as individual chips or as a single chip to include a part or all thereof. In addition, depending on the emergence of circuit integration technology that replaces LSI, it is obvious that such technology may be used to perform integration.

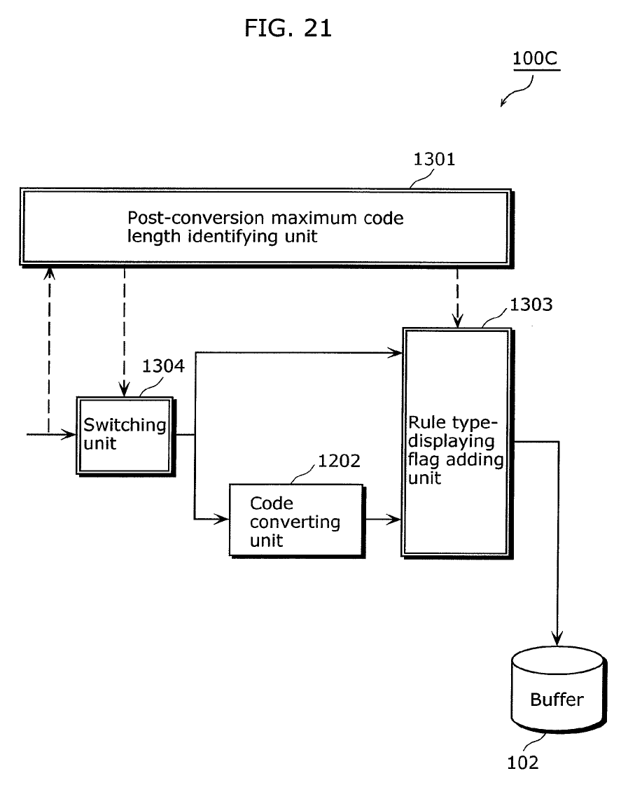

Furthermore, the decoding device in the first embodiment may further include an obtaining unit which obtains a bandwidth for the buffer, and perform code conversion only when the number of bits for each processing-unit of an inputted bitstream exceeds the obtained bandwidth. In this regard, it is preferable to affix, to the stream, an identifier for identifying whether it is a stream before conversion or a stream after conversion (see FIG. 21 and the description regarding FIG. 21).

### Second Embodiment

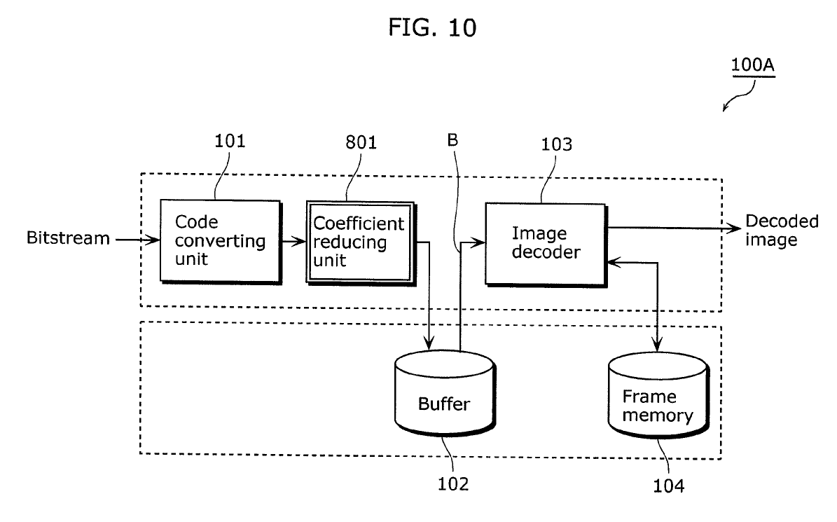

FIG. 10 is a configuration diagram of a decoding device 100A in a second embodiment of the present invention. Hereinafter, the decoding device 100A in the second embodiment of the present invention shall be described using FIG. 10.

The decoding apparatus 100A shown in FIG. 10 has a configuration in which a coefficient reducing unit 801 is added between the code converting unit 101 and the buffer 102 in the decoding device 100 shown in the first embodiment. In FIG. 10, aside from the coefficient reducing unit 801, the configuration is the same as in the first embodiment and the functions are also the same, and thus the same numerical references are given and their description shall be omitted.

The coefficient reducing unit 801 reads the bitstream outputted by the code converting unit 101 and, by removing the coefficient value of the orthogonal convert (DCT and so on) application result included in a macroblock for each of the macroblocks included in the read bitstream, reduces the bit amount of the macroblocks, so that the bit amount of the macroblock approaches a specified value. In the second embodiment, coefficient reduction is performed in the case where, even when the code conversion such as that in the first embodiment is performed, the bit amount for the macroblock is greater than a target. In the second embodiment, the maximum bit amount for the macroblocks that is obtained from the bandwidth that can be allocated to the transmission of a bitstream to the decoder is set as a target bit amount. As such, in the second embodiment, it is possible to reduce the bit amount for macroblocks so that the bandwidth required for transmitting the bitstream falls within a predicted value. It should be noted that for the target bit amount, a bit amount corresponding to the bus width of the bus B and which can be adequately transmitted using the bus B is selected.

It should be noted that an example of the “bandwidth information” in the Claims is shown in the second embodiment by the above-described target bit amount.

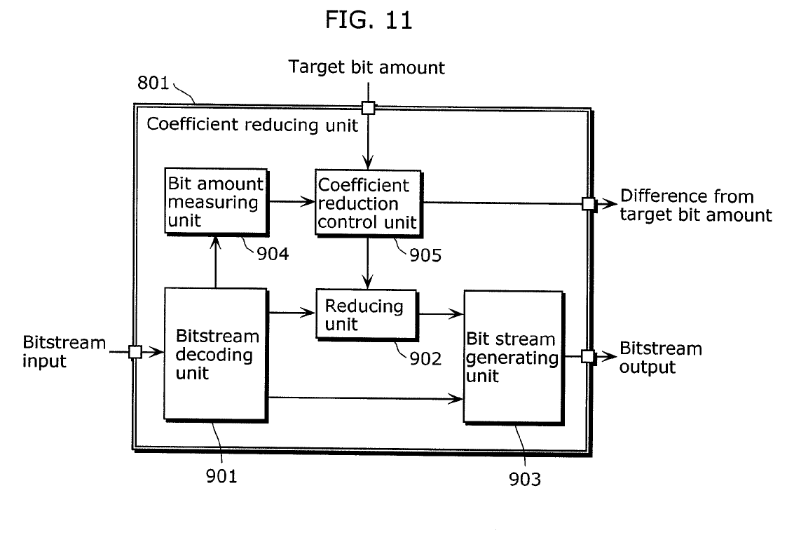

FIG. 11 is a configuration diagram of the coefficient reducing unit 801 in the second embodiment. A bitstream decoding unit 901 separates an input bitstream inputted to the decoding device 100A into a coefficient portion and non-coefficient portions, and sends the coefficient portion to a reducing unit 902 and the non-coefficient portions to a bitstream generating unit 903. Furthermore, the bitstream decoding unit 901 duplicates the input bitstream and sends this to a bit amount measuring unit 904. Following a command inputted from a coefficient reduction control unit 905, the reducing unit 902 performs the removal of coefficients from the bitstream of the coefficient portion inputted from the bitstream decoding unit 901, and reconstructs the bitstream of the coefficient portion from the result of the removal, and outputs the reconstructed bitstream. The bitstream generating unit 903 binds the bitstreams inputted from the bitstream decoding unit 901 and the reducing unit 902, and outputs the result as a bitstream. The bit amount measuring unit 904 decodes the input bitstream and outputs the macroblock bit amount or the coefficient value included in the coefficient portion and the bit amount thereof. The coefficient reduction control unit 905: obtains the difference between the target bit amount inputted from outside the coefficient reducing unit 801 and the macroblock bit amount inputted from the bit amount measuring unit 904; determines whether or not to remove a coefficient and the coefficient value to be removed based on the value of the obtained difference and the coefficient value, and the bit amount thereof, included in the coefficient portion inputted from the bit amount measuring unit 904; and generates a command for the reducing unit 902. Furthermore, the coefficient reduction control unit 905 obtains the difference between the macroblock bit amount after coefficient reduction and the target bit amount, and holds this difference in the coefficient reduction control unit 905 since it will be used in target bit amount control spanning plural macroblocks. It should be noted that, although stored in a target bit amount storing unit outside of the coefficient reducing unit 801 for example, the above-described target bit amount to be inputted from outside the coefficient reducing unit 801 may be inputted to the coefficient reducing unit 801, and may be inputted as a target bit amount calculated by a target bit amount calculating unit outside of the coefficient reducing unit 801.

Hereinafter, the operation of the coefficient reducing unit 801 shall be described.

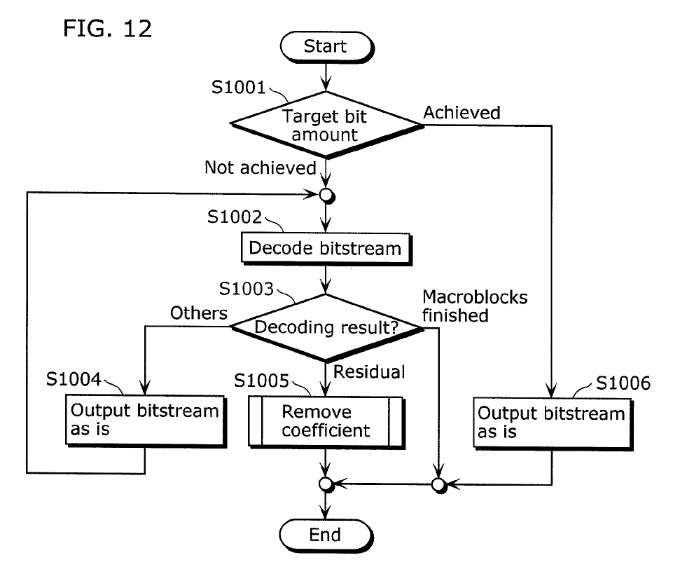

FIG. 12 shows, in a flowchart, the operation performed on macroblocks by the coefficient reducing unit 801. The coefficient reducing unit 801 first compares the macroblock bit amount and the target bit amount (step S1001). When it is judged, according to the comparison in step S1001, that the macroblock bit amount is less than the target bit amount, the coefficient reducing unit 801 outputs the bitstream inputted to the coefficient reducing unit 801 as it is (step S1006, step S1001: achieved). When it is judged, according to the comparison in step S1001, that the macroblock bit amount is greater than the target bit amount (step S1001: not achieved), the bitstream decoding unit 901 decodes the bitstream (step S1002). Next, the coefficient reducing unit 801 checks whether the decoding result in step S1002 is a residual corresponding to the coefficients, and outputs the bitstream of the portion decoded in step S1002 as it is (step S1004) when the decoding result is not a residual (step S1003: others), and the process returns to step S1002. On the other hand, when the decoding result in step S1002 is a residual, the process proceeds to the coefficient removal step S1005 (step S1003: residual), and when the macroblocks are finished, the process ends (step S1003: macroblocks finished). When the decoding result is judged as being a residual according to the judgment in step S1003 (step S1003: residual), the reducing unit 902 performs the reduction of the bit amount through coefficient removal (step S1005). It should be noted that, as long as the bitstream continues, the reducing unit 902 repeatedly performs the macroblock processing shown in FIG. 12.

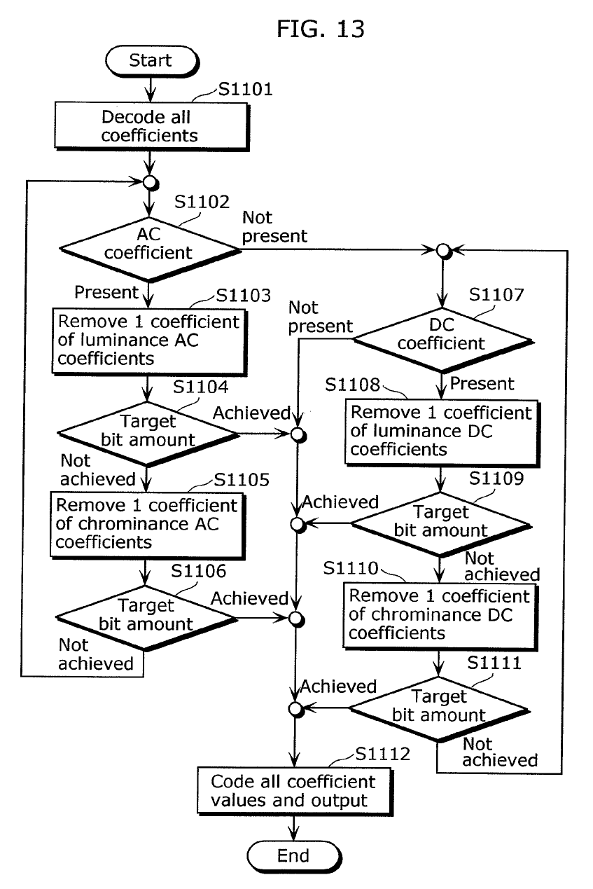

FIG. 13 shows, in a flowchart, the operation in the coefficient removal performed by the reducing unit 902 in step S1005 in FIG. 12. The basic operating rules for the reducing unit 902 are as follows. Hereinafter, the details of FIG. 13 shall be described. It should be noted that all the steps in FIG. 13 are performed by the reducing unit 902.

(1) Remove from the AC coefficients (high-frequency component out of the orthogonal convert application result), and remove DC coefficients (direct current component out of the orthogonal convert application result) only when there are no more AC coefficients.

(2) In the removal of the AC coefficients and the DC coefficients, luminance coefficient removal and chrominance coefficient removal are performed alternately.

(3) Bit amount judgment is performed each time one coefficient is removed and ends at the point when the target is reached.

(4) Coefficient removal is performed on a coefficient having a non-zero value.

In performing the processing in step S1005 in. FIG. 12, that is, the processing in FIG. 13, the reducing unit 902 first performs the decoding of all coefficients in a coefficient decoding step S1101. With such step S1101, the luminance AC coefficients, the luminance DC coefficients, the chrominance AC coefficients, and the chrominance DC coefficients are decoded as coefficients.

Subsequently, in an AC coefficient presence judging step S1102, the reducing unit 902 first checks whether a non-0 value is present in the AC coefficients decoded in step S1101, and the process proceeds to a DC coefficient judging step S1107 when a non-0 value is not present (step S1102: not present) and proceeds to a luminance AC coefficient removing step S1103 when present (step S1102: present).

In the luminance AC coefficient removing step S1103, the reducing unit 902 first removes one coefficient corresponding to the highest frequency and having the largest value among the non-0 coefficients of the luminance AC coefficients decoded in step S1101, and obtains the macroblock bit amount after the removal.

Subsequently, in a target bit amount judging step S1104, the reducing unit 902 checks whether the macroblock bit amount obtained in step S1103 has reached the target, and the process proceeds to a chrominance AC coefficient removing step 1105 when the target is not reached (step S1104: not achieved) and proceeds to a coefficient coding step S1112 when reached (step S1104: achieved).

In the chrominance AC coefficient removing step 1105, the reducing unit 902 first removes one coefficient corresponding to the highest frequency and having the largest value among the non-0 coefficients of the chrominance AC coefficients decoded in step S1005, and obtains the macroblock bit amount after the removal.

Subsequently, in a target bit amount judgment step S1106, the reducing unit 902 checks whether the macroblock bit amount obtained in step S1105 has reached the target. The process proceeds to the AC coefficient presence judging step S1102 in order to perform the removal of an AC coefficient again when the target is not reached (step S1106: achieved), and proceeds to the coefficient coding step S1112 when reached (step S1106: not achieved).

In the DC coefficient judging step S1107, the reducing unit 902 first checks whether a non-0 value is present in the DC coefficients decoded in step S1101, and the process proceeds to the coefficient coding step S1112 when a non-0 value is not present (step S1107: not present) and proceeds to a luminance DC coefficient removing step S1108 when present (step S1107: present).

In the luminance DC coefficient removing step S1108, the reducing unit 902 first removes one coefficient having the largest value among the non-0 coefficients of the luminance DC coefficients decoded in step S1101, and obtains the macroblock bit amount after the removal.

Subsequently, in a target bit amount judging step S1109, the reducing unit 902 checks whether the macroblock bit amount obtained in step S1108 has reached the target, and the process proceeds to a chrominance DC coefficient removing step 1110 when the target is not reached (step S1109: not achieved) and proceeds to the coefficient coding step S1112 when reached (step S1109: achieved).

In the chrominance DC coefficient removing step S1110, the reducing unit 902 first removes one coefficient having the largest value among the non-0 coefficients of the chrominance DC coefficients decoded in step S1101.

Subsequently, in a target bit amount judging step S1111, the reducing unit 902 checks whether the macroblock bit has reached the target, and the process proceeds to the DC coefficient judging step 1107 when the target is not reached (step S1111: not achieved) and more coefficients are removed, and proceeds to step S1112 when reached (step S1111: achieved).

When the target is reached, the process proceeds to the coefficient coding step S1112. Lastly, in the coefficient coding step S1112, the reducing unit 902 codes the luminance AC coefficients, the luminance DC coefficients, the chrominance AC coefficients, and the chrominance DC coefficients on which the above-described reduction process has been performed, and outputs the result as a bitstream. The coding is configured so as to output the format after the application of the code conversion performed by the code converting unit 101.

As described above, the decoding device 100A is configured to include: a coefficient reducing unit 801 (see coefficient reducing control unit 905, FIG. 11) which obtains a target bit amount selected in accordance with a bandwidth through which a bitstream is transmitted between the buffer 102 and the outside of the buffer 102; and a reducing unit 902 which judges whether or not the bit amount of a macroblock included in a bitstream after conversion has been performed by the code converting unit 101 exceeds the obtained target bit amount (see steps S1104, S1106, S1109, and S1111 in FIG. 13), and when it is judged that the data length will exceed the target bit amount (step S1104: not achieved, and the like), the reducing unit 902 reduces the number of bits of the macroblock on which such judgment has been made.

In addition, in such a decoding device 100A, the reducing unit 902 removes a DC coefficient when, between AC coefficients and DC coefficients, an AC coefficient is not included (step S1102: not present, in FIG. 13).

Furthermore, the reducing unit 902 judges whether or not the bit amount of the macroblock from which a luminance coefficient has been removed (step S1103, S1108) has reached the target (step S1104, S1109), and removes a chrominance coefficient of the macroblock (step S1105, step S1110) only when it is judged that the bit amount of the macroblock from which a luminance coefficient has been removed has not reached the target (step S1104: not achieved, step S1109: not achieved).

In this manner, among the four types of coefficients of the luminance AC, the luminance DC, the chrominance AC, and the chrominance DC, and based on a removing priority that decreases in such sequence, the reducing unit 902 reduces the bit amount for a macroblock by removing a coefficient having the highest priority among the types of coefficients included in the macroblock.

There are cases where the macroblock bit amount is larger than the target bit amount even when coefficients are removed in the above-described procedure. In such a case, the holding of the difference from the target bit amount by the coefficient reduction control unit 905 is utilized, and the target bit amount for a subsequent macroblock is reduced by such difference. In other words, in such a case, the coefficient reduction control unit 905 reduces, by the aforementioned difference, the target bit amount in the processing of the subsequent macroblock. With this operation, it is possible to reduce the increase in bandwidth caused by a macroblock for which the target bit amount has not been reached.

In this manner, in the second embodiment, it is possible to increase or decrease the bit amount for macroblocks on a macroblock basis. Using this allows for applications such as reducing the overall bandwidth for image decoding by reducing the target bit amount for a macroblock on which motion compensation is to be performed, and using, in reference image transmission, the bandwidth for stream transmission that has been reduced as a result thereof.

Next, a method for applying the present embodiment to CAVLC (Context Adaptive Variable Length Coding) codes in the H.264 standard shall be described. First, a method for restructuring the luminance DC coefficients, the luminance AC coefficients, the chrominance DC coefficients, and the chrominance AC coefficients in the coefficient decoding step S1101 (FIG. 13) shall be described. In the standard, the coefficients after an orthogonal convert are coded as a residual_block, and have the below-mentioned five types.

(1) Intra16×16DCLevel

Luminance DC coefficients (block size 16×16, 16 coefficients)

(2) Intra16×16ACLevel

Luminance AC coefficients (block size 16×16, 16 sets of 15 coefficients)

(3) LumaLevel

Luminance coefficients (block size 4×4 or 8×8, 16 sets of 16 coefficients)

(4) ChromaDCLevel

Chrominance DC coefficients (in a 4:2:0 format, 2 sets of 4 coefficients)

(5) ChromaACLevel

Chrominance AC coefficients (in a 4:2:0 format, 8 sets of 15 coefficients)

Among the coefficients to be restructured, the chrominance DC coefficient and the chrominance AC coefficients can be used, as is, as the restructured results. On the other hand, the luminance DC coefficients and the chrominance AC coefficients are used by selecting from the following three, according to the orthogonal convert block size for the macroblock.

(1) When the block size is 16×16

For the luminance DC coefficients, Intra16×16DCLevel is used.
For the luminance AC coefficients, Intra16×16ACLevel is used.

(2) When the block size is 8×8

For the luminance DC coefficients, LumaLevel [i] [0](i=0, 4, 8, 12) is used.
For the luminance AC coefficients, a LumaLevel other than that above is used.

(3) When the block size is 4×4

For the luminance DC coefficients, LumaLevel [i] [0](0≦i≦15) is used.
For the luminance AC coefficients, a LumaLevel other than that above is used.

With the above-described procedure, it is possible to restructure the luminance DC coefficients, the luminance AC coefficients, the chrominance DC coefficients, and the chrominance AC coefficients. With regard to subsequent coefficient removal, the method indicated in the description of the coefficient removing step S1005 can be applied as is. In the re-coding of the result of the application of coefficient removal, the Level_Prefix and Level_Suffix in the coding of the coefficient values shall be as in FIG. 9. With this, the correct image can be decoded with an image decoder 103 that is the same as that in the first embodiment.

Although the second embodiment of the present invention has been described thus far, various modifications are possible for the second embodiment without exceeding the feature of reducing the number of bits of the macroblocks through coefficient removal. As a specific modification, a method which utilizes the changing of coefficient values in bit amount reduction is also possible, aside from the application to moving picture coding standards such as MPEG-2 or VC-1 or coefficient removal.

It should be noted that each function block shown in FIG. 10 is typically implemented as an LSI which is an integrated circuit. The broken lines in FIG. 10 indicate typical configurations of an LSI, and indicate the integration of the code converting unit 101, the coefficient reducing unit 801, and the image decoder 103 as an LSI, and the integration of the buffer 102 and the frame memory 104 as a memory LSI such as a DRAM and so on. However, the method of integration is not limited to this example, and the respective functions may be made as individual chips or as a single chip to include a part or all thereof. In addition, depending on the emergence of circuit integration technology that replaces LSI, it is obvious that such technology may be used to perform integration.

### Third Embodiment

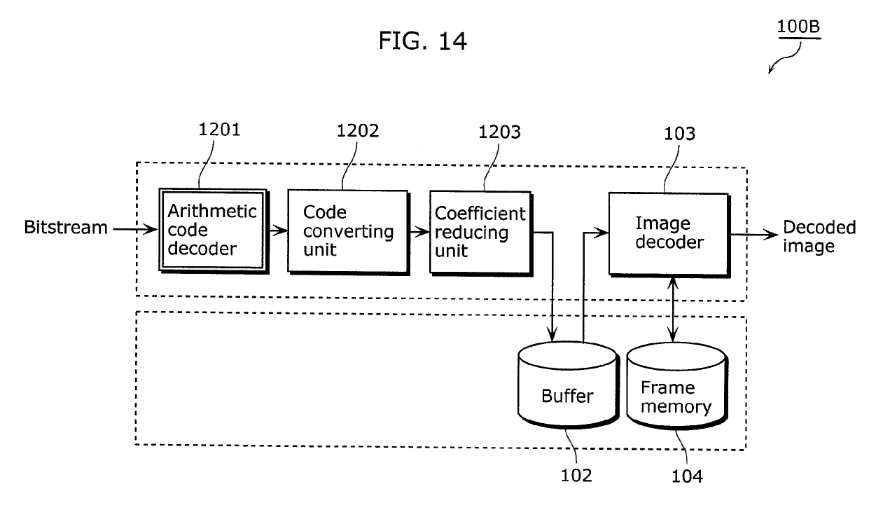

FIG. 14 is a configuration diagram of a decoding device 100B in a third embodiment of the present invention. Hereinafter, the operation of the decoding device 100B in the third embodiment shall be described using FIG. 14.

In the decoding device 100B shown in FIG. 14, an arithmetic code decoder 1201 is added to the bitstream input of the decoding device 100A shown in the second embodiment. The parts other than the arithmetic code decoder 1201, a code converting unit 1202, and a coefficient reducing unit 1203 in FIG. 14 have the same functions as those in the second embodiment, and thus the same numerical references are given to the same constituent elements and their description shall be omitted.

The arithmetic code decoder 1201 performs arithmetic decoding on a bitstream that has been coded using CABAC (Context Adaptive Binary Arithmetic Coding) codes in the H.264 standard, and outputs the decoding result as a bitstream.

Here, with CABAC codes in the H.264 standard, the bitstream of the coding result is compressed using arithmetic codes. With the arithmetic codes used in CABAC codes, since decoding must be a serial process, it is difficult to obtain a decoding performance that suits the processing performance of the image decoder. Consequently, a decoding device which handles CABAC codes is configured so that the decoding results for the arithmetic codes are stored in the buffer 102 corresponding to the CPB of the standard, and the image decoder decodes the result of the decoding of the arithmetic codes. However, with this configuration, since the restored results of compressing the arithmetic codes are transmitted to the image decoder, the maximum bit amount for the macroblocks is large at about 5000 bits, and the required bandwidth for transmitting the decoding results from the buffer 102 to the image decoder becomes extremely large. In order to solve this problem, in the third embodiment, the code conversion described in the first embodiment or the coefficient value conversion described in the second embodiment is applied to the large portion occupied by the arithmetic code decoding result.

Hereinafter, the processing by the code converting unit 1202 and the coefficient reducing unit 1203 in FIG. 14 in the application to CABAC codes in the H.264 standard shall be explained.

First, the code conversion performed by the code converting unit 1202 shall be described. With the code converting unit 1202, code conversion is applied to reference image indices (ref_idx_I0, ref_idx_I1) and a quantization parameter (mb_qp_delta), in addition to the motion vectors (mvd_I0, mvd_I1) and the coefficient values (coeff_abs_level_minus1, coeff_sign_flag). Hereinafter, the code conversion for each element shall be described.

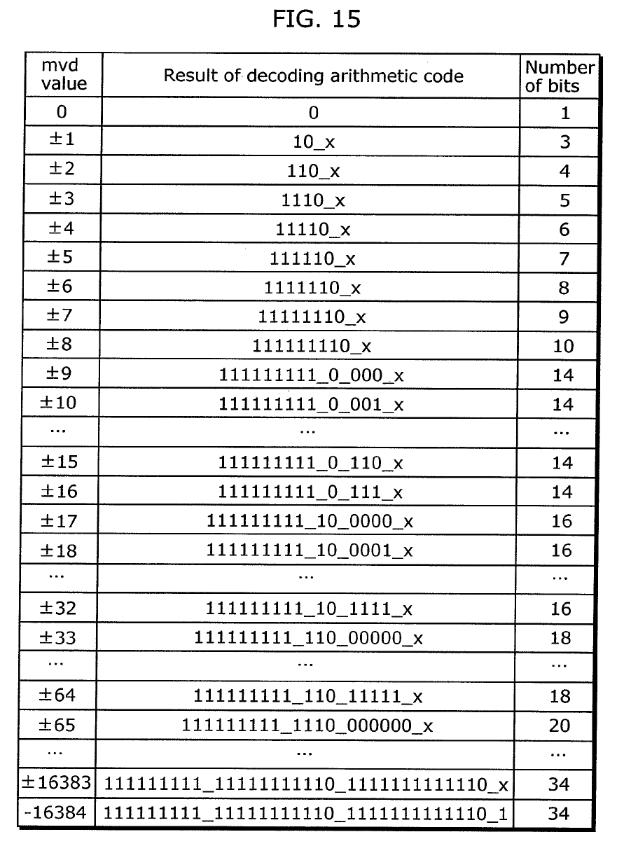

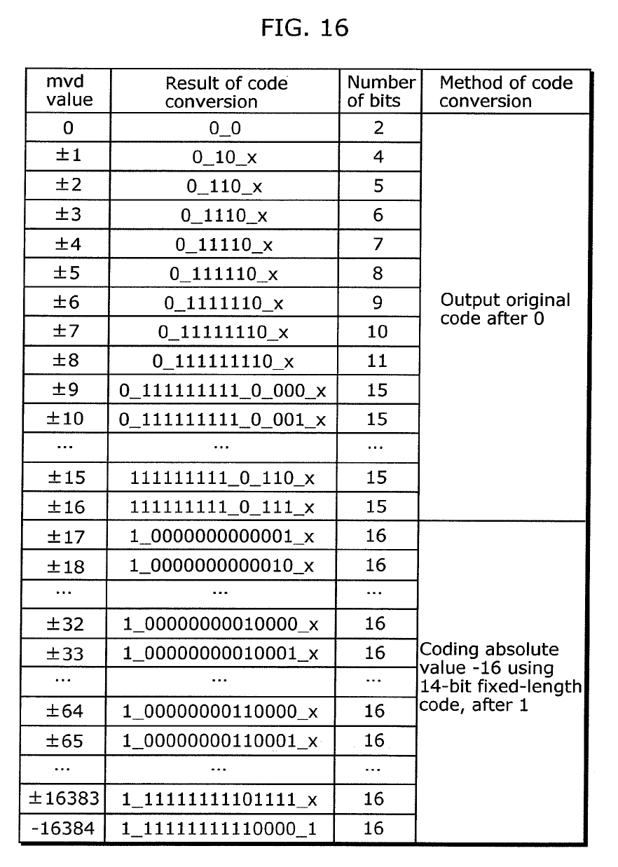

FIG. 15 shows the codes of the motion vectors (mvd_I0, mvd_I1) prior to conversion. The x in the figures from FIG. 15 onward is a code bit indicating positive and negative for a value indicated by a code; 0 denotes positive and 1 denotes negative. FIG. 16 shows codes resulting from the conversion of the above-mentioned codes for shortening the maximum code length. Since the value of the motion vectors is restricted to −16384 to 16383 in the standard, a motion vector can be denoted using a 15-bit fixed-length code.

Consequently, with the codes in FIG. 16, a value for which the original code exceeds 15 bits and the absolute value is 17 or higher is coded using a fixed-length code, and the rest is coded using the original code. In this coding, since it is necessary, at the time of decoding, to judge which between fixed-length codes and the original codes is used in the coding, 1 bit for judging the coding is added before the codes. The 1 bit to be added is an identification bit of a code after conversion in the third embodiment. With this, the maximum code length is reduced from 34 bits to 16 bits. On the other hand, for a value having an absolute value of 16 or less and using the original code as is, the code length becomes longer by 1 bit due to the addition of a bit for judging the coding. However, the bandwidth for transmitting, to the decoder, the bitstream which is the subject of the reduction in the present invention is determined in accordance with the maximum number of bits of the macroblocks, and, for the macroblock having the maximum number of bits, the bit amount for indicating motion vectors is large and it is often that the absolute value is a value of 17 or higher, and thus the increase in the code length of values for which the absolute value is 16 and below does not pose a problem.

It should be noted that in the case of the coding rule in FIG. 16, long code length codes are the codes of respective values for which the absolute value is 17 or higher, short code length codes are the codes of respective values for which the absolute value is below 17, and the switching size is 14 bits (see number of bits for codes of values 0 to ±16 in FIG. 15).

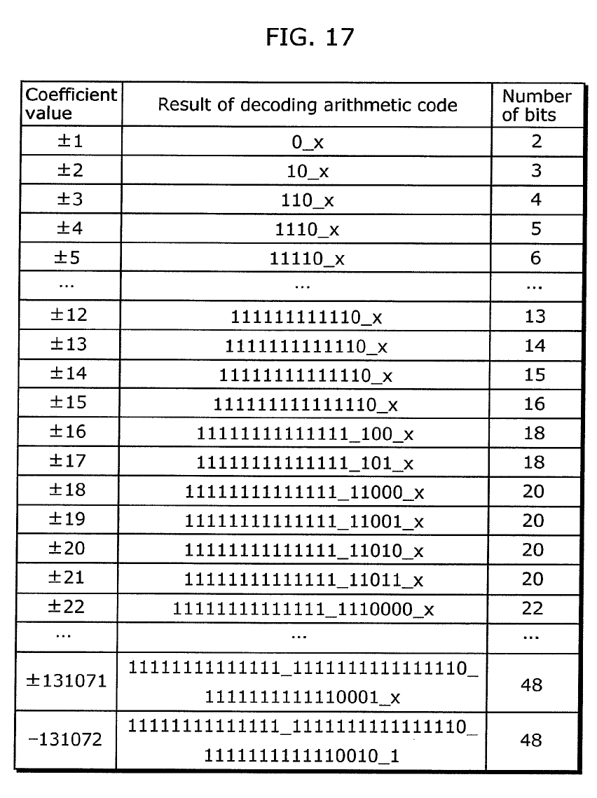

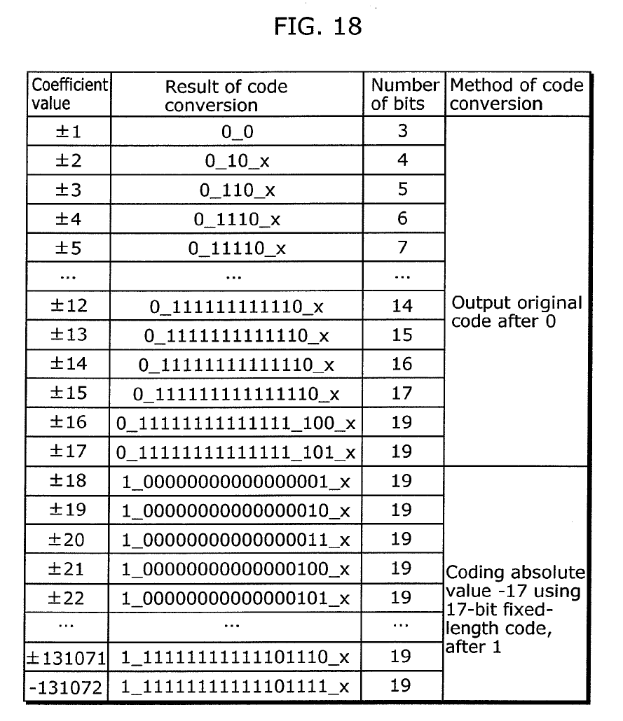

FIG. 17 shows the codes for the coefficient values (coeff_abs_level_minus1, coeff_sign_flag) before conversion. Since the coefficient values are restricted to −131072 to 131071, the coefficient values can be represented using 18-bit fixed-length codes. Consequently, when the codes are converted with the same concept as with the motion vectors, the result is as shown in FIG. 18, and values having an absolute value of 18 or higher are denoted using fixed-length code. According to this code conversion, whereas the maximum code length can be reduced from 48 bits to 19 bits, the bit length increases by 1 bit when the absolute value is 17 or lower. However, with coefficient values, as with motion vectors, the absolute value for a macroblock having the maximum number of bits is often 18 or higher, and thus, even when the code length for values having an absolute value of 17 or lower increases, this poses no particular problem.

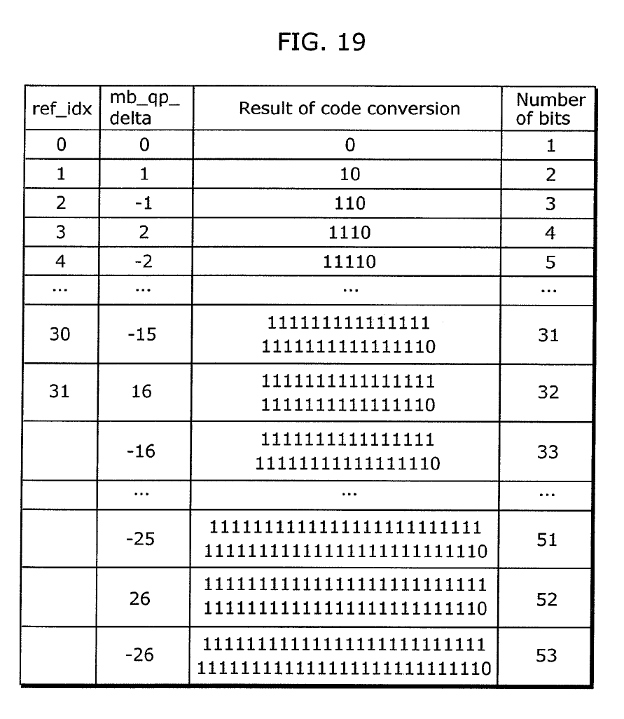

FIG. 19 shows the codes for the reference image indices (ref_idx_I0, ref_idx_I1) and the quantization parameter (mb_qp_delta) before conversion. In order to increase the compression efficiency of arithmetic codes, the codes before conversion use Unary Binarization which denotes a value by the number of 1s up to the appearance of 0, and aside from the maximum code length, the average code length is also large. Consequently, for the reference image indices and the quantization parameter, values are coded using Exp-Golomb code in which both the maximum code length and the average cod length are shortened.

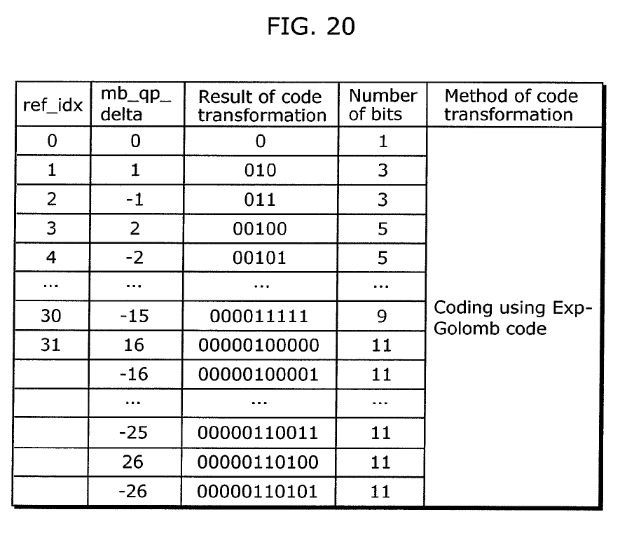

FIG. 20 shows codes after conversion, and the maximum code length can be reduced from 53 bits to 11 bits. Since this conversion is not in a format which switches codes according to values, that is, a format in which the codes after conversion are separated into long code length codes and short code length codes, a bit for judging the coding (for example, the above-described respective identification bits) is not required, although the code length for 1 and 4 of the reference image indices and 1 and −2 of the quantization parameters increases by 1 bit. However, in the macroblock having the maximum number of bits, the motion vectors and coefficient values occupy most of the number of bits and the number of bits for these is significantly reduced through the previously described conversion, and thus the increase in the number of bits for the reference image indices and the quantization parameters does not pose a particular problem.

In this manner, although the format in which the codes after conversion are separated into long code length codes and short code length codes has been described in detail in the foregoing description (see FIG. 7, FIG. 9, FIG. 16, and FIG. 18), the format is not limited to the format of separating into long code length codes and short code length codes, and other formats may be used. For example, the format described using FIGS. 19 and 20 is one of such other formats.

The code converting unit 1202 in the third embodiment has been described thus far. With the code conversion shown here, the maximum bit amount for the macroblocks can be reduced from approximately 5000 bits to approximately 3500 bits. It should be noted that the code conversion shown here is merely one example, and various modifications are possible without exceeding the essence of reducing the maximum code length by code conversion. Specifically, there is a method in which the original codes are not outputted as is, and are instead converted into Exp-Golomb codes, and so on.

Next, the coefficient reducing unit 1203 in third embodiment shall be described. Since the coefficient reducing unit 1203 in third embodiment is configured in the same manner as the coefficient reducing unit 1203 described in the second embodiment, description regarding the configuration shall be omitted.

Next, the procedure for coefficient reduction in CABAC in the H.264 standard shall be described. With the CABAC codes in the H.264 standard, the handling of the luminance DC coefficients and luminance AC coefficients in an orthogonal convert with an 8×8 block size is different with that in the CAVLC codes in the H.264 standard shown in the second embodiment. Consequently, when the block size is 8×8, the luminance DC coefficients use LumaLevel8×8[0][0](0≦i≦3), and the luminance AC coefficients a use a LumaLevel8×8 other than the above. Other than this, the operation of the coefficient reducing unit 1203 is the same as that in the case of the CAVLC codes in the H.264 standard described in the second embodiment.

Even in the third embodiment, there are cases where the macroblock bit amount after coefficient removal is larger than the target bit amount. In such a case, it is possible to utilize the outputting of the difference from the target bit amount by the coefficient reduction control unit 905 included in the coefficient reducing unit 1203 in the third embodiment, and perform control such as causing the target bit amount for a subsequent macroblock to be reduced by such difference.

In this manner, in the third embodiment, the bandwidth for transmitting a bitstream to the image decoder can be increased or decreased on a macroblock basis. Using this allows for control such as reducing the target bit amount for a macroblock on which motion compensation is to be performed, and using, in reference image transmission, the bandwidth for stream transmission that has been reduced, and thus reducing the overall bandwidth required for image decoding.

Thus far, the third embodiment has been described exemplifying a bitstream that has been coded using CABAC codes in the H.264 standard. It should be noted that the method for code removal shown here is merely one example, and various modifications are possible without exceeding the feature of the present configuration of reducing the code length of macroblocks by removing coefficients and the like. As an example of a modification, it is possible to have a method that reduces values instead of removing coefficients.

It should be noted that each function block shown in FIG. 14 is typically implemented as an LSI which is an integrated circuit. The broken lines in FIG. 14 indicate typical configurations of an LSI, and indicate the integration of the arithmetic code decoder 1201, the code converting unit 1202, the coefficient reducing unit 1203, and the image decoder 103 as an LSI, and the integration of the buffer 102 and the frame memory 104 as a memory LSI such as a DRAM and so on. However, the method of integration is not limited to this example, and the respective functions may be made as individual chips or as a single chip to include a part or all thereof. In addition, depending on the emergence of circuit integration technology that replaces LSI, it is obvious that such technology may be used to perform integration.

Here, the code converting unit 1202 converts codes into the codes in the coding rule shown in FIG. 16.

In the coding rule in FIG. 16, when the value is ±17, that is, the absolute value is 17 for example, the code corresponding to such value is “1_{—}00000000000001_x”. Here, the body of such code is “00000000000001_x”, and is an equal-length code denoting an equal-length code value ±1. Specifically, the absolute value of the mvd value is 17, the absolute value of the equal-length code value is 1, which are mutually different.

In this manner, in the coding rule in FIG. 16, each mvd value is associated with a long code length code of an equal-length code having an equal-length code value different from such mvd value. The coding rule in FIG. 16 include a value association such as a value and an equal-length code value of a long code length code associated with such value. More specifically, in the coding rule in FIG. 16, through the association between a value and a long code length code, the value and the equal-length code value for the long code length code thereof have a value association. In the coding rule in FIG. 16, the value association associates an mvd value with the equal-length code value of an absolute value resulting from the subtraction of 16 from the absolute value of such mvd value. As such, as described above, when the value is ±17, the code associated with such value is the equal-length code of the absolute value equal-length code value ±1 of 17−16=1.

With this, even without using an equal-length code having many bits for denoting an equal-length code value of a wide range, the mvd value can be recorded using an equal-length code having few bits, such as, for example, an equal-length code having the minimum bits corresponding to the number of the mvd value denoted by a long code length code.

It should be noted that this point is also true for the coding rule in FIG. 18, and in the coding rule in FIG. 18, the code corresponding to the long code length code is an equal-length code having the equal-length code value of an absolute value resulting from the subtraction of 17 from the absolute value of the coefficient value of such code.

It should be noted that, in the third embodiment, according to the two's complement principle, instead of denoting the equal-length code value, the body of the code shown in FIG. 16 and FIG. 18 is configured of a code bit denoting the positive and negative of such equal-length code value, and absolute value equal-length code denoting the absolute value of such equal-length code value, as described above. As such, the absolute value of the minimum value and the absolute value of the maximum value of the equal-length code denoted by the body are mutually the same. For example, when the body is m bits, the absolute value equal-length code is m−1 bit, and 2 raised to the (m−1)th power is L, the body denotes −(L−1) to +(L−1), and the absolute value which is mutually the same is L−1. Meanwhile, since there are many cases where the absolute value of the minimum value and the absolute value of the maximum value of the value associated with the body according to the identification bit by the coding rules are mutually the same, the above-described value association is simplified by using a body using a code bit as described above. Consequently, it is possible to simplify the configuration of the code converting unit 1202 which processes the above-described value association.

### Fourth Embodiment

As a fourth embodiment, a modification of the third embodiment (see FIG. 14, and so on) shall be described. It should be noted that description of items that are the same as in the third embodiment shall not be repeated in the fourth embodiment.

FIG. 21 is a diagram showing a decoding device 100C in the fourth embodiment.

The decoding device 100C includes a post-conversion maximum code length identifying unit 1301, a rule type-displaying flag adding unit 1303, and a switching unit 1304.

The post-conversion maximum code length identifying unit 1301 identifies the maximum code length from among the code lengths of codes included in macroblocks after codes are converted by the code converting unit 1202. More specifically, the post-conversion maximum code length identifying unit 1301 identifies three types of maximum code lengths, that is, it identifies the maximum code length among codes (see FIG. 15) of motion vectors (hereinafter called motion vector code maximum code length), the maximum code length among the code lengths of the codes of coefficient values (see FIG. 17) included in such macroblocks (hereinafter called coefficient value code maximum code length), and the maximum code length among the codes of the reference image indices and quantization parameters (see FIG. 18) (hereinafter called third maximum code length). It should be noted that, for example, by identifying the code having the maximum absolute value among codes of motion vectors prior to conversion, the post-conversion maximum code length identifying unit 1301 identifies, as the motion vector code maximum code length, the code length of the code after transmission which corresponds to the identified code prior to transmission.

Only in the case where the motion vector code maximum code length identified by the post-conversion maximum code length identifying unit 1301 exceeds a predetermined motion vector threshold length, the switching unit 1304 causes the code converting unit 1202 to perform code conversion on the motion vectors included in the macroblock from which the post-conversion maximum code length identifying unit 1301 has identified the motion vector code maximum code length.

Furthermore, only in the case where the coefficient value code maximum code length identified by the post-conversion maximum code length identifying unit 1301 exceeds a predetermined coefficient value threshold length, the switching unit 1304 causes the code converting unit 1202 to perform code conversion on the coefficients included in the macroblock of the coefficient value code maximum code length.

Furthermore, only in the case where the third maximum code length identified by the post-conversion maximum code length identifying unit 1301 exceeds a predetermined third threshold length, the code converting unit 1202 causes the code converting unit 1202 to perform code conversion on the reference image indices, and so on, included in the macroblock of the third maximum code length.

It should be noted that the switching unit 1304 performs such a switching (see FIG. 21) by switching between inputting the motion vectors, and so on, to the rule type-displaying flag adding unit 1303 via the code converting unit 1202, and inputting the motion vectors directly to the rule type-displaying flag adding unit 1303 without passing through the code converting unit 1202. It should be noted that such configuration of the switching unit 1304 is one example, and the switching unit 1304 may adopt other configurations.

The rule type-displaying flag adding unit 1303 adds a rule type-display flag, which indicates whether or not code conversion has been performed by the code converting unit 1202, to the macroblock inputted to the rule type-displaying flag adding unit 1303 by either the switching unit 1304 or the code converting unit 1202. The rule type-display flag includes a motion vector flag indicating whether or not motion vector code conversion has been performed, a coefficient value flag indicating whether or not the coefficient values have been code converted, and a third flag indicating whether or not code conversion has been performed on the reference image indices, and so on. The rule type-displaying flag adding unit 1303 adds such three rule type-display flags to the macroblock. At this time, for example, the size of the macroblock may be increased by the size of the 3 rule type-display flags, that is, by 3 bits, and it is also possible to have the size of the 3 rule type-display flags pre-existing inside the macroblock prior to adding, such that the macroblock does not increase in size.

In the fourth embodiment, the image decoder 103 (FIG. 4) identifies, based on the rule type-display flags, the coding rule by which the macroblock including such rule type-display flags has been coded. When the motion vector flag indicates that code conversion has been performed, the image decoder 103 identifies that the coding rule for the motion vectors of the macroblock of the motion vector flag is the coding rule in FIG. 16, and identifies the coding rule is the coding rule in FIG. 15 when the motion vector flag indicates that code conversion has not been performed. Furthermore, the image decoder 103 identifies the coding rule for the coefficient values and the reference image indices, and so on, in the same manner. Subsequently, the image decoder 103 performs the processing for the decoding which corresponds to the respective identified coding rules for the motion vectors, coefficient values, and reference image indices, and so on.

The embodiments of the present embodiment have been described thus far by exemplifying some embodiments. Aside from the embodiments described herein, various modifications are possible for the present invention without departing from the essence of reducing the maximum number of bits of a macroblock by code conversion and removal of information such as a coefficient value. For example, aside from an image decoding device in the H.264 standard described above, the present invention can also be applied, in the same manner, to an image decoding device compliant with the MPEG-2 standard or the VC-1 standard. Furthermore, aside from performing the conversion of codes or the removal of coefficients using an independent circuit, it is also possible to have a configuration such that such processing is performed simultaneously with demultiplexing in which the process of separating audio and video from a stream is performed.

### INDUSTRIAL APPLICABILITY

The decoding device in the present invention: includes a converting unit which converts codes coded according to a first coding rule into codes according to a second coding rule which reduces the maximum code length; and is useful in televisions, personal computers, DVD recorders, and the like.

1. An image data decoding device which decodes image data, said image data decoding device comprising:
a code converting unit configured to convert image data inputted to said image data decoding device into image data coded according to a second coding rule in which a maximum code length is shorter than in a first coding rule used to code the inputted image data;
a buffer which stores the image data after the conversion by said code converting unit; and
a decoding unit configured to obtain, from said buffer, the image data after the conversion by said code converting unit, and to decode the obtained image data.

2. The image data decoding device according to claim 1,
wherein the image data includes motion vectors and coefficient values,
said code converting unit includes:
a motion vector code converting unit configured to convert the motion vectors included in the image data and coded according to the third coding rule into motion vectors coded according to a fourth coding rule in which a maximum code length is shorter than in the third coding rule; and
a coefficient value code converting unit configured to convert the coefficient values included in the image data and coded according to the fifth coding rule into coefficient values coded according to a sixth coding rule in which a maximum code length is shorter than in the fifth coding rule, and
the conversion by said motion vector code converting unit and said coefficient value code converting unit are performed on the image data.

3. The image data decoding device according to claim 1, further comprising
a bandwidth information obtaining unit configured to obtain bandwidth information identifying a bandwidth through which the image data is to be transmitted between said buffer and an outside of said buffer,
wherein said code converting unit is configured to convert the image data when data length of a unit-of-transmission having a maximum data length, among units-of-transmission for the transmission of the image data, exceeds the bandwidth identified by the bandwidth information, the units-of-transmission being included in the image data.

4. The image data decoding device according to claim 1, further comprising
a bandwidth information obtaining unit configured to obtain bandwidth information identifying a bandwidth through which the image data is to be transmitted between said buffer and an outside of said buffer;
a judging unit configured to judge whether or not data length of a unit-of-transmission for the transmission of the image data exceeds the bandwidth identified by the bandwidth information, the unit-of-transmission being included in the image data after the conversion by said code converting unit; and
a reducing unit configured to reduce the number-of-bits of the unit-of-transmission on which judgment is performed, when said judging unit judges that the data length exceeds the bandwidth.

5. The image data decoding device according to claim 4,
wherein said reducing unit is configured to remove a DC coefficient only when, among AC coefficients and DC coefficients, an AC coefficient is not included in the unit-of-transmission of the image data.

6. The image data decoding device according to claim 4,
wherein said judging unit is configured to judge whether or not the data length of the unit-of-transmission from which a luminance coefficient has been removed by said reducing unit exceeds the bandwidth identified by the bandwidth information, and
said reducing unit is configured to remove a chrominance coefficient of the unit-of-transmission only when it is judged that the data length of the unit-of-transmission from which the luminance coefficient has been removed exceeds the bandwidth.

7. The image data decoding device according to claim 1,
wherein, in the first coding rule, codes that are associated with values according to the first coding rule have sizes of mutually unequal length, and
in the second coding rule:
values respectively associated with small codes equal to or smaller than a predetermined size according to the first coding rule are each associated with a corresponding one of codes each including, in at least a part of the code, a code that is identical to the corresponding small code; and
values respectively associated with big codes that are bigger than the predetermined size according to the first coding rule are each associated with a corresponding one of codes having the predetermined size and including predetermined equal-length codes of mutually equal length.

8. The image data decoding device according to claim 7,
wherein the size is a minimum number of bits required when coding, using equal-length codes, all the values associated according to the first coding rule,
the equal-length codes are codes of equal-length made up of the minimum number of bits, and
the codes in the second coding rule each include: a body including either a code that is identical to a code in the first coding rule or the equal-length code; and an identification bit which is one bit for identifying whether the body includes either the code identical to the code in the first coding rule or the equal-length code.

9. The image data decoding device according to claim 8,
wherein the second coding rule includes a value association between values indicated by the codes in the first coding rule and equal-length code values indicated by the equal-length codes, and
said code converting unit is configured, when converting the code in the first coding rule into the code including the equal-length code, to select, as the included equal-length code, a code of the equal-length code of an equal-length code value associated, in the value association, with a value indicated by the code in the first coding rule.

10. The image data decoding device according to claim 9,
wherein, in the value association, each of the values in the first coding rule is associated with an equal-length code of an equal-length code value having an absolute value resulting from subtraction of a predetermined subtrahend from an absolute value of the value.

11. The image data decoding device according to claim 1, further comprising
a maximum code length identifying unit configured to identify, based on the image data before the conversion, a maximum code length in the image data after the conversion,
wherein said code converting unit is configured to perform the conversion when the maximum code length identified by said maximum code length identifying unit exceeds a predetermined size, and
said image data decoding device further comprises
a flag adding unit configured to attach a conversion display flag to the image data obtained by said decoding unit, the conversion display flag indicating whether or not the conversion by said code converting unit has been performed.

12. The image data decoding device according to claim 1,
wherein, in the second coding rule, an average code length is longer than in the first coding rule.

13. The image data decoding device according to claim 1,
wherein the image data is image data in H.264 standard, and
said image data decoding device further comprises
an arithmetic decoding unit configured to perform arithmetic decoding in H.264 standard on the image data before the conversion by said code converting unit.

14. The image data decoding device according to claim 1, further comprising
a bus for transmitting the image data between said buffer and an outside of said buffer,
wherein each of the coding rules is an association between a value and a code denoting the value,
the code is a bit string in which plural 1-bit data are lined up,
the maximum code length is the number of bits of a bit string of a code having the bit string that is longest, among the codes with which corresponding ones of values are associated in the respective coding rules, and
said code converting unit is configured to convert each of the codes included in the image data into a code which, in the second coding rule, is associated with a value with which the code included in the image data is associated in the first coding rule.

15. An image data decoding method of decoding image data, using an image data decoding device, said method comprising:
converting image data inputted to the image data decoding device into image data coded according to a second coding rule in which a maximum code length is shorter than in a first coding rule used to code the inputted image data;
storing, in a buffer, the image data after the conversion in said converting; and
obtaining, from the buffer, the image data after the conversion in said converting, and decoding the obtained image data.

16. An integrated circuit which decodes image data, said integrated circuit comprising:
a code converting unit configured to convert image data inputted to said integrated circuit into image data coded according to a second coding rule in which a maximum code length is shorter than in a first coding rule used to code the inputted image data;
a buffer which stores the image data after the conversion by said code converting unit; and
a decoding unit configured to obtain, from said buffer, the image data after the conversion by said code converting unit, and to decode the obtained image data.

17. An image data decoding device which decodes image data in H.264 standard, said image data decoding device comprising:
a code converting unit configured to convert image data inputted to said image data decoding device into image data coded according to a second coding rule in which a maximum code length is shorter than in a first coding rule used to code the inputted image data;
a decoding unit configured to obtain the image data after the conversion by said code converting unit, and to decode the obtained image data; and
an arithmetic decoding unit configured to perform arithmetic decoding in the H.264 standard on the image data before the conversion by said code converting unit.

18. An image data decoding method of decoding image data in H.264 standard, using an image data decoding device, said method comprising:
converting image data inputted to the image data decoding device into image data coded according to a second coding rule in which a maximum code length is shorter than in a first coding rule used to code the inputted image data;
obtaining the image data after the conversion in said converting, and decoding the obtained image data; and
performing arithmetic decoding in the H.264 standard on the image data before the conversion in said converting.

19. An integrated circuit which decodes image data in H.264 standard, said integrated circuit comprising:
a code converting unit configured to convert image data inputted to said integrated circuit into image data coded according to a second coding rule in which a maximum code length is shorter than in a first coding rule used to code the inputted image data;
a decoding unit configured to obtain the image data after the conversion by said code converting unit, and to decode the obtained image data; and
an arithmetic decoding unit configured to perform arithmetic decoding in the H.264 standard on the image data before the conversion by said code converting unit.
